(19) United States
(12) Patent Application Publication
(10) Pub. No.: US 2001/0022575 A1
(43) Pub. Date: Sep. 20, 2001

(54) Input device for a computer

(76) Inventor: Richter Woflgang, Bockhorn (DE)

Correspondence Address: Jonathan O. Owens, HAVERSTOCK & OWENS LLP, 260 Sheridan Avenue, Suite 420, Palo Alto, CA, 94306, US

(21) Appl. No.: 09/839,873

(22) Filed: Apr. 20, 2001

(30) Foreign Application Priority Data
Oct. 21, 1998 (EP) PCT/EP98/06675

(51) Int. Cl. G09G 5/00

(52) U.S. Cl. 345/156

(57) ABSTRACT

An input device for a computer having a graphical user interface, having a display device that is connected to the computer and that is designed to reproduce contents generated by the computer in a display area and is connected to the computer, a camera device that covers at least one part of the display area and can be connected to the computer and that comprises at least one beam directed by a transmitter device designed to emit a directed electromagnetic beam into the display area and generates a signal that is characteristic of the position at which the beam strikes a surface in the display area and/or of the path and the direction which/in which a beam traverses that strikes a surface in the display area, and wherein the characteristic signal for controlling the execution of a computer program in the computer makes it possible for one or more users to act on the events imaged on the display (screen) surface of the computer regardless of the size of the display area and his spatial distance from it or to be able to trigger instructions.

### BACKGROUND OF THE INVENTION

The present invention relates to an input device for a computer. In particular, the invention relates to an input device for computers having a graphical user interface.

### PRIOR ART

In the prior art, computer mice, joy-sticks, trackballs or also graphical tablets, etc., have been disclosed as input devices for computers having a graphical user interface. These input devices have a number of different disadvantages.

On the one hand, it is necessary for a user to take hold of the mouse, the trackball or the input pen of the graphical tablet to operate the computer. The mouse and the input pen of the graphical tablet then have to be guided over a surface, while the display screen of the computer on which a symbol is displaced in accordance with the movement of the mouse or of the input pen of the graphical tablet has to be observed at the same time. The coordination of the movement of the mouse or of the input pen of the graphical tablet with the displacement of the symbol on the display screen presents difficulties for some users.

In addition, during the reproduction of the display-screen content on large display walls, for example, the computer operator is forced to stay at a table or the like across whose surface he moves the mouse to input instructions. This is an appreciable limitation in presentations and frequently has the result that a first individual sitting at a table operates the computer by means of the mouse and a second individual is necessary to explain the content presented by means of the computer on the large-screen wall.

Even a trackball held in the hand by the presenter and having a wireless (infrared) interface with the computer is only to a limited extent an improvement in this connection. This is due to the fact that untrained presenters have, as a rule, difficulties in inputting instructions into the computer with the aid of the trackball during simultaneous eye contact with the large-screen wall.

All these input devices described above have the disadvantage that direct access to symbols in the display area is impossible. On the contrary, a transformation of a relative movement of a sphere in a mouse with respect to another surface or a sphere in a trackball has to take place by means of the fingers of the user.

Only if the user has access to the display screen directly, so to speak at arm's length, can touch-sensitive display screens (touch screens) be used in which a matrix of (infrared) light beams is interrupted by the fingers or a pen, or a contact film having a grid of contact points is touched with the finger or a pen. This variant is, however, ruled out in large-screen walls onto which the display screen content is projected.

In addition to the limitation of such touch-sensitive display screens with regard to their size, all the hitherto known input devices have the periphery of the display (screen) area as a boundary. In other words, existing input devices are not capable both of inputting instructions or controlling events that are imaged on the display (screen) surface of the computer and of reacting to events that take place in the vicinity of the display (screen) surface of the computer.

### THE PROBLEM UNDERLYING THE INVENTION

The object of the invention is accordingly to provide an input device for computers in which one or more users can act on events imaged on the display (screen) surface of the computer or trigger instructions regardless of the size of the display area and his/her spatial distance therefrom.

### ACHIEVEMENT ACCORDING TO THE INVENTION

To solve the problem, the invention provides an input device comprising a display device that is connected to the computer and that is designed to reproduce a content generated by the computer in a display area, and a camera device that covers at least a part of the display area and can be connected to the computer and that detects at least one beam directed at the display area by a hand-held transmitter device designed to emit a directed electromagnetic beam and generates a signal that is characteristic of the position at which the beam strikes a surface in the display area and/or the path and the direction that/in which a beam traverses that strikes the surface in the display area, and wherein the characteristic signal serves to control the execution of a computer program in the computer.

The invention consequently makes it possible to use the oldest human non-verbal method of communication directly and immediately for computer engineering: pointing at symbols or objects with the index finger. When this is done, the human finger is “made longer” by the directed (light) beam and is made easily identifiable and locatable for engineering. The invention make possible the triggering of instructions in computer programs as a result of the light beam, for example, from a commercial light pointer or so-called laser pointer, being directed at a symbol on the display (screen) surface in the display area. When this is done, a user sees the light point generated by the laser pointer directly on the display (screen) surface and can directly swing the light spot unrestrictedly in the display area by changing the direction in which he holds the light pointer. This is detected by the camera device, which generates a signal that is characteristic of the position or the path and the direction and that is fed to the computer (program) via an interface of the computer or an operating system routine of the computer in order to convert the signal into equivalent operating instructions. Switching operations, such as those triggered by a key on a conventional computer mouse, a conventional trackball or the like can also be triggered by switching the light pointer off or by switching the light pointer rapidly on/off without moving the position of the light spot.

Consequently, not only a virtually unrestricted number of individuals situated in front of the display area can effect instructions or other (data) inputs in the computer by directing a light beam onto the display (screen) wall by means of a light pointer held in their hand. On the contrary, it is also possible to dispose the display area with the display (screen) wall behind a display-window glass pane so that passers-by can interact with the computer at any desired time.

In addition, the individual users can very easily become active with their light pointer also in a plurality of computer programs running in parallel in different display areas. Furthermore, the free mobility of the user or of the users is no longer limited since the light pointer no longer has to be connected via a conductor to the computer.

In the display area, a two-dimensional picture can be created on a display screen wall and a three-dimensional picture in a projection room. Suitable for two-dimensional pictures is a film projector or a video projection device (a so-called video gun). Suitable for three-dimensional pictures are laser projection devices or hologram projectors.

In a preferred embodiment of the invention, the transmitter device is designed to emit a directed electromagnetic beam, preferably a visible light beam, it being possible that the electromagnetic beam is provided with a code characteristic of the transmitter device. The light beam may be generated by an ultrabright LED arrangement (with an optical system disposed in front of the latter) or by a semiconductor laser arrangement, the code being modulated on (by frequency, amplitude, phase modulation or the like). At the same time, it is also possible to use a conventional filament lamp as visible light source for the beam and, in addition, to emit, for example, a focused, modulated infrared light beam. In this connection, for battery saving reasons, the conventional filament lamp as main visible source for the beam may also be dispensed with if the computer program is designed to generate a corresponding light spot on the display screen wall as a checkback signal for the user.

In accordance with an advantageous embodiment of the invention, an interface that converts the characteristic signal into a data format for the operating system of the computer or that can be further processed by the program running in the computer is provided between the camera device and the computer.

There is a plurality of alternatives for the embodiment of the camera device. In accordance with a first embodiment, the camera device is a CCD camera that has a CCD sensor and an optical system connected upstream of the latter, preferably with a lens/diaphragm arrangement.

In this connection, the CCD sensor is preferably connected to a control circuit for reading out row by row or column by column, and wherein, when a beam directed from a transmitter device into the display area is detected by the CCD sensor, the control circuit emits its coordinates and preferably a “beam detected” signal at a data output for the computer.

In accordance with a second embodiment, the camera device has a picture sensor comprising a photosensitive detector matrix and an optical system connected upstream of the latter, preferably having a lens/diaphragm arrangement.

In this connection, the detector matrix is preferably connected to a control circuit, wherein, when a beam directed from a transmitter device into the display area is detected by the detector matrix, the control circuit emits its coordinates and preferably a “beam detected” signal at a data output for the computer.

In accordance with a third embodiment, the camera device has a picture sensor comprising a lateral effect diode and an optical system connected upstream of the latter, preferably with a lens/diaphragm arrangement.

In this connection, the lateral effect diode is preferably connected to a control circuit wherein the control circuit has analogue/digital converters that are connected to the outputs of the lateral effect diode and that convert its output signals into X, Y coordinates, and preferably a comparator that, when a beam directed from a transmitter device into the display area is detected by the lateral effect diode, emits a “beam detected” signal and its coordinates at a data output for the computer.

Lateral effect diodes substantially comprise a large-area rectangular photodiode having electrodes at the sides.

Depending on the position of the light beam striking the surface, a corresponding current is emitted at the various electrodes. The differential currents are consequently a measure of the position of the light beam striking the surface or of the light spot produced thereby. Consequently, regardless of the size of the light spot, its position or its change can be detected very accurately and with high speed.

Other embodiments of the camera devices are also possible in principle. It is only necessary for the camera device to be capable of detecting the display area with a resolution that makes possible a sufficiently accurate positional or vector determination (according to absolute value and direction) of the light spot on the surface in the display area.

The invention relates also to a driver program for detecting coordinates by means of an input device described above, comprising the following steps:

-a- reading the coordinate data and, if present, the “beam detected” signal from the interface into appropriate registers or memory locations of the computer;

-b- checking whether the contents of the register or of the memory location or of the registers or memory locations are zero,

and if so, repeating step -a-;

-c- transformation of the contents of the register or memory locations into display screen coordinates by means of conversion factors determined by previous calibration; and

-d- transmission of the display screen coordinates in the form of an asynchronous mouse pointer positioning event to the operating system of the computer.

Furthermore, the invention also relates to a driver program for detecting a key event by means of an input device described above, comprising the following steps:

-a- resetting of a register containing an empty event counter or of the memory location;

-b- reading the coordinate data and, if present, the “beam detected” signal from the interface into corresponding registers or memory locations of the computer;

-c- checking whether the contents of the empty event counter or of the display screen coordinates are zero, and if so, incrementing the empty event counter and repeating step -b-;

-d- checking whether the empty event counter does not exceed a predetermined value,

and if so

-e- transmission of an asynchronous mouse key event to the operating system of the computer.

As a result of the two driver programs or program parts described above, a conventional mouse or a conventional trackball can be replaced by means of the input device according to the invention, it being unnecessary to make any changes whatsoever with regard to the programs running in the computer. only the functionality of the light pointer, which is appreciably extended but simplified in operation, is available to the user.

Finally, the invention also relates to a method of carrying out adjustments by means of the input devices described above, comprising the following steps:

-a- specifying the peripheries of at least two locally disjoint selection areas within the display area;

-b- detection of the radiation intensities occurring in each of the selection areas of beams directed by the transmitter devices into the display area; and

-c- transmission of values reproducing the respective intensities to the computer.

As a simpler alternative to this, one selection area or even the entire display area can be projected in each case with the aid of an optical arrangement and of an optical filter that transmits only light of the wavelength of the light pointers onto a sensor that converts the detected light intensity into an equivalent electrical signal. Said electrical signal is converted by means of control electronics (comprising a microcontroller) into a data format that can be transmitted to the computer by means of a serial or parallel interface and evaluated in the computer.

In addition to simultaneously offering two or more alternatives involving corresponding selection areas that are simultaneously offered for the adjustment, a sequential display of the factual situations to be adjusted may also take place in the display area. In this connection, all the light spots from light pointers detected in the display area during a predetermined time interval are then detected by the sensor, summed (for example by means of a sample/hold switching circuit or a counter) and then converted into a data format that can be transmitted to the computer by means of a serial or parallel interface and evaluated in the computer.

A calibration of the camera device relative to the display screen wall in the display area is necessary for the correct functioning of the invention. Said calibration can take place in such a way that a test picture is projected into the display area, coordinates of particular, conspicuous points in said test picture being known to the computer program. A light beam is directed at said points by means of a transmitter device, while the computer (controlled by the computer program) indicates in which direction the camera device has to be swung in a controlled manner (by hand or by means of suitable servomotors) before the light beam directed at said point is detected.

The individual features of the claims can also be combined in a manner deviating from the retrospective referencing of the claims. Protection is also claimed for such combinations of the features according to the invention.

Further features, properties and advantages of the present invention are explained on the basis of the description below of the figures.

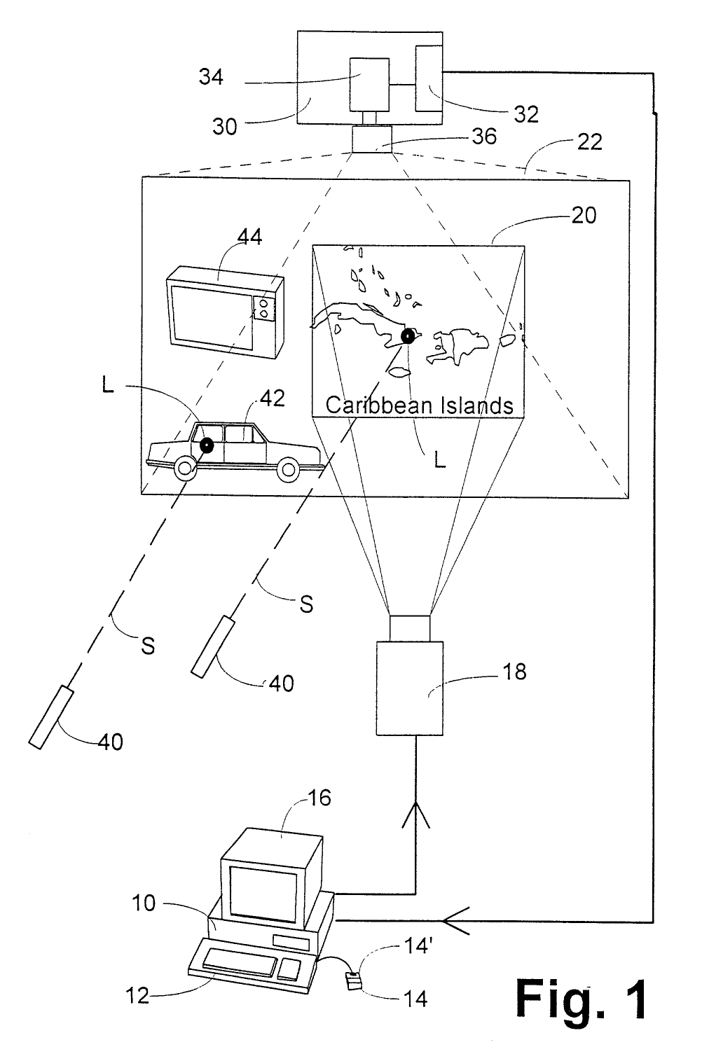

FIG. 1 shows a schematic block circuit diagram of the input device according to the invention.

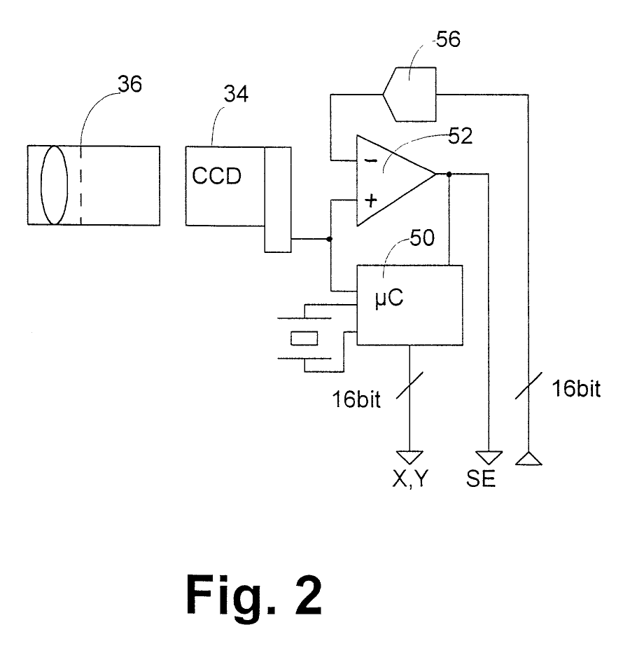

FIG. 2 shows a detail of a camera device of the input device according to the invention shown in FIG. 1 in a first embodiment.

The input device shown in FIG. 1 is intended for a computer in the form of a PC 10 that has a keyboard 12, a conventional computer mouse 14 and a monitor 16. Installed in the computer 10 is an operating system comprising a graphical user interface. A user can thereby displace a pointer symbol on the monitor 16 by displacing the computer mouse 14 on a (table) surface and can trigger an instruction or an action in the operating system of the computer or an application program running in the computer by actuating a key 14′ on the computer mouse 14.

In order to be able to display the contents shown on the monitor 16 to a fairly large number of individuals, the computer 10 is connected via its video output to a projector 18 that projects the contents onto a display wall 20 in a display area 22. In this connection, the display area 22 may even be greater than the actual display wall 20 on which the contents generated by the computer 10 are to be seen.

Furthermore, a camera device 30 that is an essential part of the input device according to the invention is connected to the computer 10 via the serial interface of the latter. The camera device 30 detects the display area 22 completely and can consequently detect events that take place on the display wall 20 and also those actions that occur in the vicinity of the display wall 20.

According to the invention, such an action or such an event is a directed light beam S from a transmitter device 40 in the form of a light pointer or so-called laser pointer that generates a light spot L on an object 42, 44 or another surface in the display area if an individual observing the display area 22 directs such a light pointer into the display area 22 and actuates it.

The camera device 30 detects the beam S or the light spot L generated thereby and generates a signal that is characteristic of the position at which the beam S strikes a surface in the display area 22 and/or of the path and the direction which/in which a beam S traverses that strikes a surface in the display area 22.

An interface 32 assigned to the camera device 30 converts said signal by means of a microcomputer into a data format for the operating system of the computer or a data format that can be further processed in the program running in the computer 10.

In this embodiment, the camera device 30 is a CCD camera that has a CCD sensor 34 and an optical system that is connected upstream of the latter and has a lens/diaphragm arrangement 36.

The details of the camera device 30 are illustrated in FIG. 2. The CCD sensor 34 is connected to a control circuit 50 for reading out row by row or column by column.

When a light spot L of a beam S is detected in the display area 22 by the CCD sensor 34, the control circuit 50 emits its coordinates (X, Y) and a “beam detected” signal (SE) at a data output for the computer 10. A comparator 52 is used for this purpose whose one non-inverting input is connected to the output of the CCD sensor 34 and whose second, inverting input is connected to an actuator 54, which is either a potentiometer or a D/A converter 56 that can be programmed from the computer 10. Consequently, the intensity that a light spot must have can be adjusted so that it can be recognized as such (compared with other light sources). To determine the position of the light spot, the control circuit 50 reads the CCD sensor 34 cell by cell in a row-by-row manner. As soon as the comparator 52 emits a positive signal edge at its output, the read-out operation is terminated. The number of cells read-out divided by the number of cells per row yields the Y-coordinate and the integral residue the X-coordinate of the position of the light spot L as projected on the sensor surface.

These data are then transmitted either via a parallel or a serial interface to the computer in which a driver program is stored that performs the following functions:

-a- reading the coordinate data X,Y and, if present, the “beam detected” signal SE from the interface into appropriate registers or memory locations X_POS; Y_POS; SIG_PRES of the computer 10;

-b- checking whether the contents of the register or of the memory location SIG_PRES or of the registers or memory locations X_POS and Y_POS are zero,

and if so, repeating step -a-;

-c- transformation of the contents of the register or memory locations X_POS and Y_POS into display screen coordinates X_SCREEN; Y_SCREEN by means of conversion factors determined by previous calibration; and

-d- transmission of the display screen coordinates X_SCREEN; Y_SCREEN in the form of an asynchronous mouse pointer positioning event to the operating system of the computer.

With such a driver program, the operating system or an application program to which asynchronous mouse pointer positioning events are transmitted by said driver program behaves exactly as if a conventional computer mouse, trackball or the like had been activated.

In order also to have the function of a key actuation in the case of a conventional computer mouse, trackball or the like, the driver program has been extended by the following program steps:

-a- resetting of a register containing an empty event counter or of the memory location KEY COUNT;

-b- reading the coordinate data X, Y and, if present, the “beam detected” signal SE from the interface into corresponding registers or memory locations X_POS; Y_POS; SIG_PRES of the computer 10;

-c- checking whether the contents of the register or of the memory location SIG_PRES or of the registers or memory locations X_POS and Y_POS are zero,

and if so, incrementing the empty event counter (KEY_COUNT) and repeating step -b-;

-d- checking whether the empty event counter (KEY_COUNT) does not exceed a predetermined value (MAX),

and if so

-e- transmission of an asynchronous mouse key event to the operating system of the computer.

To improve the accuracy, two camera devices 30 displaced at a distance from one another may also be provided that are each connected to the computer via an interface. In this case, it is necessary for the drive program to read the data out of the two camera devices 30 and to generate therefrom an asynchronous mouse pointer positioning event and to transmit it to the operating system of the computer.

1. Input device for a computer having a graphical user interface, comprising
a display device that is connected to the computer and that is designed to reproduce contents generated by a computer in a display area and is connected to the computer,
a camera device that covers at least one part of the display area and can be connected to the computer and that
comprises at least one beam directed by a transmitter device designed to emit a directed electromagnetic beam into the display area and generates a signal that is characteristic of the position at which the beam strikes a surface in the display area and/or of the path and the direction which/in which a beam traverses that strikes a surface in the display and wherein
the characteristic signal serves to control the execution of a computer program in the computer.

2. Input device for a computer having a graphical user interface according to claim 1, comprising
an interface that converts the characteristic signal into a data format for the operating system of the computer or that can be further processed by the program running in the computer is provided between the camera device and the computer.

3. Input device for a computer having a graphical user interface according to claim 1 or 2, wherein
the camera device is a CCD camera that has a CCD sensor and an optical system connected upstream of the latter, preferably with a lens/diagram arrangement.

4. Input device for a computer having a graphical user interface according to claim 3, wherein
the CCD sensor is connected to a control circuit for reading out row by row or column by column, and wherein, when a beam directed from a transmitter device into the display area is detected by the CCD sensor, the control circuit emits its coordinates (X, Y) and preferably a “beam detected” signal at a data output for the computer.

5. Input device for a computer having a graphical user interface according to claim 1 or 2, wherein
the camera device has a picture sensor comprising a photosensitive detector matrix and an optical system connected upstream of the latter, preferably having a lens/diaphragm arrangement.

6. Input device for a computer having a graphical user interface according to claim 5, wherein
the detector matrix is connected to a control circuit, and wherein, when a beam directed from a transmitter device into the display area is detected by the detector matrix, the control device emits its coordinates (X, Y) and preferably a “beam detected” signal at a data output for the computer.

7. Input device for a computer having a graphical user interface according to claim 1 or 2, wherein
the camera device has a picture sensor comprising a lateral effect diode and an optical system connected upstream of the latter, preferably with a lens/diaphragm arrangement.

8. Input device for a computer having a graphical user interface according to claim 7, wherein
the lateral effect diode is connected to a control circuit, and wherein the control circuit has analogue/digital converters that are connected to the outputs of the lateral effect diode and that convert its output signals into X, Y coordinates, and preferably a comparator that, when a beam directed from a transmitter device into the display area is detected by the lateral effect diode, emits a “beam detected” signal and its coordinates (X, Y) at a data output for the computer.

9. Driver program for detecting coordinates by means of an input device according to one of claims 1-8, comprising the following steps:
-a- reading the coordinate data (X,Y) and, if present, the “beam detected” signal from the interface into appropriate registers or memory locations (X_POS; Y_POS; SIG_PRES) of the computer;
-b- checking whether the contents of the register or of the memory location (SIG_PRES) or of the registers or memory locations (X_POS) and (Y_POS) are zero,
and if so, repeating step -a-;
-c- transformation of the contents of the register or memory locations (X_POS) and (Y_POS) into display screen coordinates (X_SCREEN; Y_SCREEN) by means of conversion factors determined by previous calibration; and
-d- transmission of the display screen coordinates (X_SCREEN; Y_SCREEN) in the form of an asynchronous mouse pointer positioning event to the operating system of the computer.

10. Driver program for detecting a key event by means of an input device according to one of claims 1 -9, comprising the following steps:
-a- resetting of a register containing an empty event counter or of the memory location (KEY_COUNT);
-b- reading the coordinate data (X, Y) and, if present, the “beam detected” signal from the interface into corresponding registers or memory locations (X_POS; Y_POS; SIG_PRES) of the computer;
-c- checking whether the contents of the register or of the memory location (SIG_PRES) or of the registers or memory locations (X_POS) and (Y_POS) are zero,
and if so, incrementing the empty event counter (KEY_COUNT) and repeating step -b-;
-d- checking whether the empty event counter (KEY_COUNT) does not exceed a predetermined value (MAX),
and if so
-e- transmission of an asynchronous mouse key event to the operating system of the computer.

11. Method for carrying out adjustments by means of an input device according to one of claims 1-8, comprising the following steps:
-a- specifying the peripheries of at least two locally disjoint selection areas (J, N) within the display area;
-b- detection of the radiation intensities occurring in each of the areas (J, N) of beams directed by the transmitter devices into the display area; and
-c- transmission of values (J_INTENS; N_INTENS) reproducing the respective intensities to the computer.

12. Input device for a computer having a graphical user interface according to claim 1, wherein the display device (12) is designed to reproduce a two-dimensional picture on a projection surface and/or to reproduce a three-dimensional picture in a projection room.

13. Input device for a computer having a graphical user interface according to claim 1, wherein
the transmitter device (16) is designed to emit a directed visible light beam.
